(19) United States
(12) Patent Application Publication
(10) Pub. No.: US 2007/0024812 A1
(43) Pub. Date: Feb. 1, 2007

(54) Projector

(75) Inventors: Jih-Hwa Chung, Miao Li County (TW); Chien-Chou Hsu, Miao Li County (TW)

Correspondence Address: BIRCH STEWART KOLASCH & BIRCH, PO BOX 747, FALLS CHURCH, VA, 22040-0747, US

(73) Assignee: Coretronic Corporation

(21) Appl. No.: 11/493,762

(22) Filed: Jul. 27, 2006

(30) Foreign Application Priority Data
Jul. 29, 2005 (TW) 94125829

(51) Int. Cl. G03B 21/26

(52) U.S. Cl. 353/30; 353/122

(57) ABSTRACT

A projector for projecting a first image on a screen according to first image data comprises a wireless access module for receiving signals, and an editing module for editing the received signals into second image data so as to display a second image on the screen. The first image and the second image being overlapped and displayed on the screen.

### BACKGROUND OF THE INVENTION

(1) Field of the Invention

The present invention relates to a projector, and more particularly to a projector editing a second image data to display a first image and a second image on a screen.

(2) Description of the Prior Art

Please refer to FIG. 1, which illustrates a schematic view of a conventional projector connecting to peripheral devices. The peripheral device, such as a notebook 4, generates image data for displaying an image 11 on a screen of the notebook 4 and transmits the image data to a projector 2 when the projector 2 is connected to the notebook 4. And then an image 12 displays on a screen 10 through the projector 2.

Further more, other peripheral device, such as a printer 6, is connected to the notebook 4 being capable of printing the image 11 displayed on the screen of the notebook 4 on a paper.

Another peripheral device, such as a laser pen 8, is used for generating a red spot 14 on the image 12 to facilitate a speaker to point out a specific content in the image 12 during a presentation.

Moreover, if special annotations and descriptions may actually be added onto the image 12 during the presentation, it shall use software to provide symbols and colors for such annotations and descriptions. But not all types of the software have such ability, even some do have that, the inconvenience is still existed.

For instance, utilizing the PowerPoint™ of the Microsof™ to represent the image 12 on the screen 10 and continuously drawing a red line on a specific position on the image 12 may employ a drafting toolbar to draw the red line and store that under the standard viewing mode of the PowerPoint™. It causes a complicate process, and obviously creates inconvenience.

However, the printer 6 prints out only the image 11 displayed on the notebook 4. But the red spot 14 generated by the laser pen 8 can't be printed out by the printer 6.

### SUMMARY OF THE INVENTION

An objective of the present invention is to provide a projector, which can edit second image data and display an overlapped image on a screen so as to conveniently and arbitrarily edit annotations, descriptions or indications.

Another objective of the present invention is to provide a projector printing out the overlapped image formed by the first image and the second image, and the second image directly.

The present invention is provided with a projector, which is used for projecting a first image on a screen according to first image data. The projector comprises a wireless access module for receiving signals by a way of wireless, and an editing module for editing the received signals into second image data so as to display a second image on the screen. The first image and the second image is overlapped and displayed on the screen.

### BRIEF DESCRIPTION OF THE DRAWINGS

The present invention will now be specified with reference to its preferred embodiment illustrated in the drawings, in which

FIG. 1, which illustrates a schematic view of a conventional projector connecting to peripheral devices;

FIG. 2, which illustrates a schematic view of a projector according to a preferred embodiment of the present invention;

FIG. 3, which illustrates a schematic view of a projector according to a preferred embodiment of the present invention; and

FIG. 4, which illustrates a schematic view of a displaying image according to a preferred embodiment of the present invention.

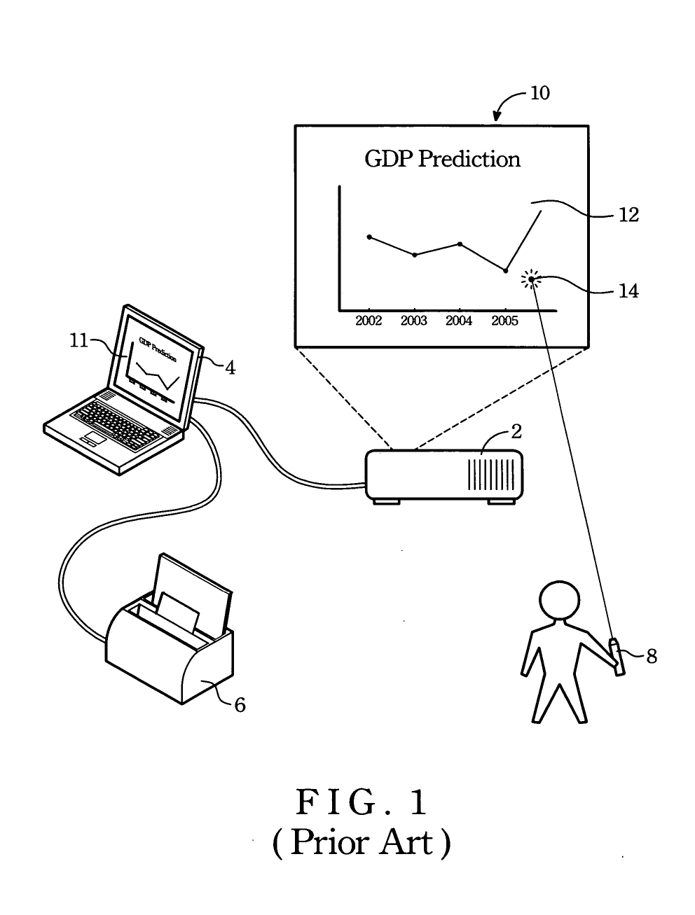

### DESCRIPTION OF THE PREFERRED EMBODIMENT

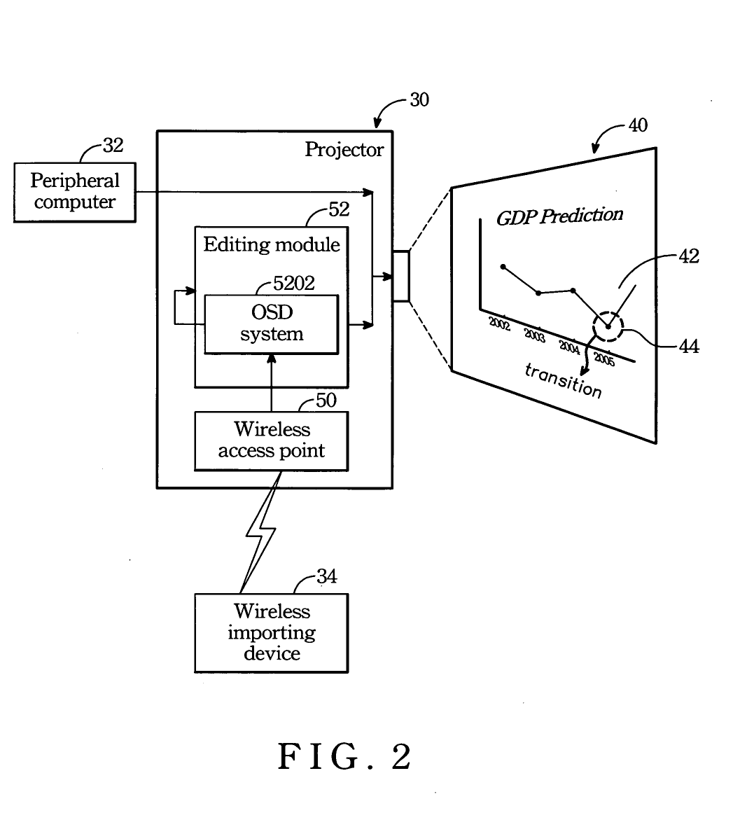

Please refer to FIG. 2, which illustrates a schematic view of a projector 30 of a preferred embodiment according to the present invention. The projector 30 connects to a peripheral computer 32. The projector 30 is used for projecting a first image 42 on a screen 40, wherein the first image 42 is according to first image data from a peripheral computer 32. The projector 30 has a wireless access module 50 and an editing module 52.

The wireless access module 50 receives signals by a way of wireless, wherein the signals produced from an exterior wireless importing device 34. The wireless importing device 34 is a wireless pen or other wireless handwriting devices. The wireless access module 50 is selected from a group consisting of an Infrared Radio communication module, a 802.11b wireless communication module, a 802.11a wireless communication module, a 802.11g wireless communication module, and a Bluetooth module.

The editing module 52 edits the received signals from the wireless access module 50 into second image data so as to display a second image 44 on the screen 40. The first image 42 and the second image 44 are displayed and overlapped on the screen 40.

The editing module 52 further has an on screen display (OSD) system 5202, which produces the second image data and displays the corresponding second image 44 on the screen 40.

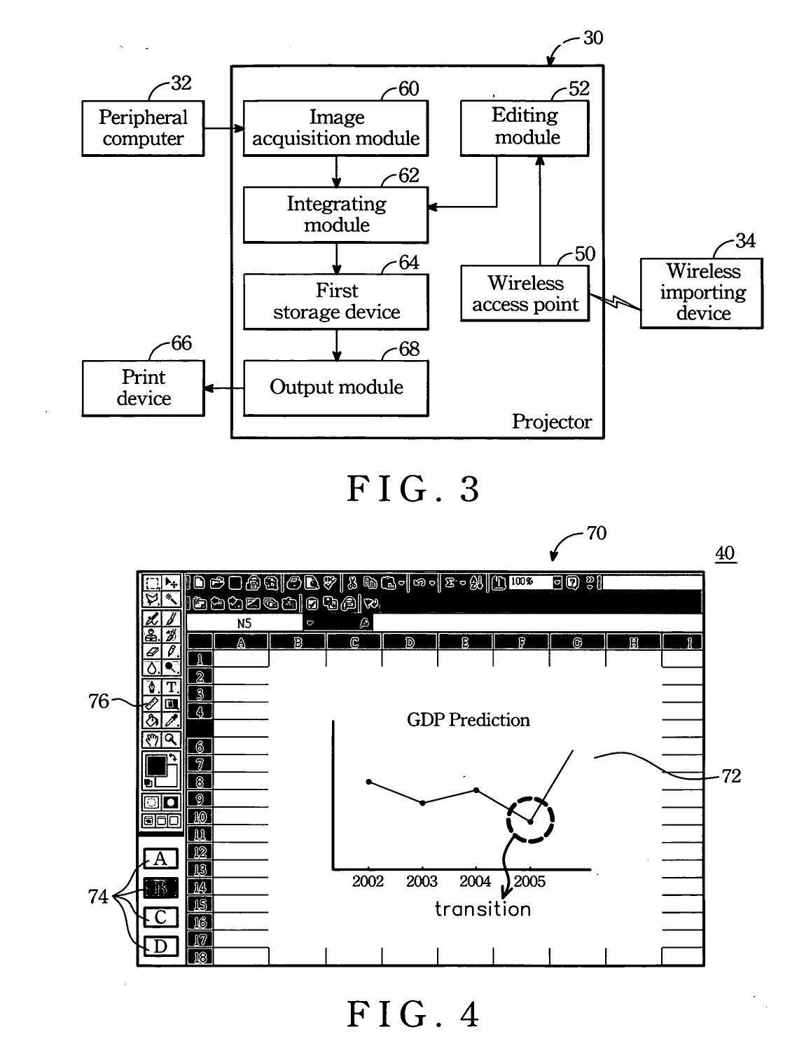

Please refer to FIG. 3, the projector 30 connects to the peripheral computer 32 and a print device 66. The projector 30 further has an image acquisition module 60, an integrating module 62, a first storage device 64, and an output module 68. The image acquisition module 60 is used for acquiring the first image data. The integrating module 62 is used for integrating the first image data and the second image data into displaying image data. The first storage device 64 is used for storing the displaying image data including the first image data and the second image data. According to the displaying image data, the first image 42 and the second image 44 are displayed and overlapped on the screen 40.

The output module 68 is connecting to peripheral devices, such as the print device 66 or a second storage device (not shown) through a connector or a wireless device. The displaying image data are output exteriorly to the print device 66. The print device 66 is used for printing the displaying image from the displaying image data. The print device 66 receives the displaying image data and then directly prints out the displaying image from the displaying image data stored in the first storage memory 64. In another embodiment, the print device 66 is embedded in the projector 30 to print out the displaying image. The output module 68 is also used for outputting the displaying data to the exterior second storage device for further uses.

Please refer to FIG. 4, which illustrates a schematic view of the displaying image of the preferred embodiment according to the present invention. The projector 30 projects a Graphical User Interface (GUI) 70 on the screen 40, wherein the GUI 70 has a main image frame 72, a plurality of registering frames 74, and a drafting toolbar 76. The main image frame 72 displays the first image 42 according to the first image data. The plurality of registering frames 74 corresponds to the second image data edited by the editing module 52 through different colors. Different users register through different registering frames 74, wherein the different second image data of the different registering frames 74 are represented the second image in different colors on the screen 40. One user only registers through one of the register frames 74 to edit the second image data by the editing module 52 and mark the second image in the same color.

The drafting toolbar 76 is used for controlling the setting conditions of the second image data edited by the editing module 52. For example, having the thicknesses, the figures, etc. of the second image data is more flexible for compiling.

As a conclusion, the projector 30 of the present invention may edit the second image 44 overlapped with the images 42 of the screen 40, and receives signals by way of wireless to edit the corresponding data via the signals so as to conveniently and arbitrarily edit annotations, descriptions, indications, etc. Further, the projector 30 supports the print device 66 to fast print out the overlapped image formed by the first image 42 and the second image 44.

While the present invention has been particularly shown and described with reference to a preferred embodiment, it will be understood by those skilled in the art that various changes in form and detail may be without departing from the spirit and scope of the present invention.

What is claimed is:

1. A projector for projecting a first image on a screen according to first image data, comprising:
a wireless access module for receiving signals; and
an editing module for editing the received signals into second image data so as to display a second image on the screen, the first image and the second image being overlapped and displayed on the screen.

2. The projector of claim 1, wherein the wireless access module is selected from a group consisting of an Infrared Radio communication module, a 802.11b wireless communication module, a 802.11a wireless communication module, a 802.11g wireless communication module, and a Bluetooth module.

3. The projector of claim 1, wherein the wireless access module further comprises a wireless importing device for receiving the signals.

4. The projector of claim 3, wherein the wireless importing device comprises a wireless pen.

5. The projector of claim 1, further comprising an image acquisition module for acquiring the first image data.

6. The projector of claim 5, further comprising:
an integrating module for integrating the first image data and the second image data into displaying image data, the first image and the second image being overlapped and displayed on the screen according to the displaying image data; and
a first storage device for storing the displaying image data.

7. The projector of claim 6, further comprising an output module for outputting the displaying image data to a peripheral device.

8. The projector of claim 7, wherein the peripheral device comprises a print device for printing a displaying image according to the displaying image data.

9. The projector of claim 7, wherein the peripheral device comprises a second storage device.

10. The projector of claim 1, further comprising a Graphical User Interface (GUI), wherein the GUI comprises a main image frame for displaying the first image according to the first image data.

11. The projector of claim 10, wherein the GUI further comprises a plurality of registering frames corresponding to the second image data edited by the editing module through different colors.

12. The projector of claim 10, wherein the GUI further comprises a drafting toolbar for controlling setting conditions of the second image data edited by the editing module.

13. The projector of claim 1, wherein the editing module further comprises an on screen display (OSD) system for producing the second image data.
